(19) United States
(12) Patent Application Publication
(10) Pub. No.: US 2016/0081127 A1
(43) Pub. Date: Mar. 17, 2016

(54) SMART HOME DEVICE AND NETWORK MANAGEMENT SYSTEM

(71) Applicants: INTELLECTUAL DISCOVERY CO., LTD., Seoul (KR); RADIOPULSE INC., Seoul (KR)

(72) Inventors: Dong Hwan LEE, Seoul (KR); Jung Ho KIM, Seoul (KR); Ju Hyung SON, Uiwang-si (KR)

(73) Assignees: RADIOPULSE INC., Seoul (KR); INTELLECTUAL DISCOVERY CO., LTD., Seoul (KR)

(21) Appl. No.: 14/888,226

(22) PCT Filed: Apr. 29, 2014
(86) PCT No.: PCT/KR2014/003775

§ 371 Date: Oct. 30, 2015

(30) Foreign Application Priority Data
Apr. 30, 2013 (KR) 10-2013-0048922
Apr. 30, 2013 (KR) 10-2013-0048923
Apr. 30, 2013 (KR) 10-2013-0048924

(51) Int. Cl. H04W 76/02; H04W 12/06; H04L 12/28

(52) U.S. Cl. CPC H04W 76/02; H04L 12/2803; H04W 12/06

(57) ABSTRACT

According to an aspect of the present invention, a smart home appliance device comprises: a controller for controlling an operation of a smart home appliance; and at least one communication module for transmitting/receiving data on the basis of a command of the controller, wherein the controller transmits an access request message to a consolidated authentication center, receives an access response message corresponding to an access request, transmits a pairing request message including device information of the smart home appliance device to the consolidated authentication center, and receives a pairing response message corresponding to the pairing request message.

### BACKGROUND

1. Field

Various exemplary embodiments of the present disclosure broadly relate to a network access method in an environment where multiple home area networks exist, and more specifically to methods, devices, and a system in which devices belonging to respective home area networks access to respective networks, and carry out pairing with other devices existing in respective networks in a case that a plurality of home area networks operate in physically adjacent positions.

2. Description of Related Art

Information technology (IT) such as internet and high-speed communications has been advancing. Due to changes of recognition on environmental problems and social interests on eco-environmental technologies, interests on smart grid technologies which are combinations of IT and electric power industry have been increased. The smart grid technology is a technology which implements a stable and highly-efficient intelligent electrical grid through the combination of IT and power electric technologies and can minimize environmental contamination and efficiently use energies. The smart grid network is a next-generation intelligent electrical grid to minimize unnecessary generation of electricity and increase efficiency of electric power usage by bi-directionally exchanging real-time information between an electric power supplier and a consumer through application of IT into conventional power electrical grids.

In the smart grid system, power generation facilities include traditional large-sized power plants such as thermoelectric power plants, hydroelectric power plants, and nuclear power plants, and various new regeneration energy plants such as solar thermal power plants, solar energy plants, and wind power plants. The above large-sized plants transmit generated electricity to power transmission stations through power transmission lines, and the power transmission stations transmit the received electricity to substations which distribute the electricity to final consumers such as home or offices. Also, electricity generated by the large-sized regeneration energy plants can be transmitted to the substations and distributed to respective consumers via the substations.

In the smart grid system, various electrical devices powered by the electricity may be connected to IT communication networks, and control energy supply and demand efficiency based on information exchange through the IT communication networks. The most significant problem of the traditional power grid is that power supply cannot be optimized since the amount of electricity used by the final consumer is not known to the power supplying sites in real time, being caused by unidirectional power supplies and simple metering facilities. However, in the smart grid environment, the amount of energy used can be collected in real-time through smart meters so that control of power generation in respective power plants and estimation of power consumption can be possible. Thus, energy costs can be differentiated according to the control and the estimation so that electricity can be efficiently distributed.

In the home smart grid environment, respective home appliances including smart meters may exchange energy-related information with each other through communications between the respective home appliances. The wired/wireless communication technologies, which can be used for achieving the above purpose, may exist in various forms. However, the most widely used technology is a ZigBee technology. The ZigBee, one of Low Rate Wireless Personal Area Network (LR-WPAN) technologies, is characterized by lower power consumption and low cost, and is implemented as a personal wireless network standard for smart grid and applications of home automation in 2.4 GHz frequency bands.

FIG. 1 illustrates respective layers to which ZigBee and IEEE 802.15.4 standard are applied.

The ZigBee is a communication standard for near-distance networking, and adopts IEEE 802.15.4 standard as its Medium Access Control (MAC) layer and Physical (PHY) layer. Also, its network layer and application layer are defined by a ZigBee Alliance. The ZigBee can provide near-distance communication services within a range of several tens of meters in environments such as home, office, etc. and is one of communication technologies which can realize ubiquitous computing by implementing ‘Internet of Things (IoT)’. Especially, the ZigBee can minimize power consumption so that it can be equipped even in various battery-powered devices such as smart grid devices or home sensors.

Referring to the ZigBee standards, the ZigBee can use frequency bands of 2.4 GHz, 915 MHz, and 868 MHz which are industrial, scientific, and medical (ISM) bands. Also, it can use 16 channels in 2.4 GHz band to provide a transmission speed up to 250 Kbps, 10 channels in 915 MHz band to provide a transmission speed up to 40 Kbps, and one channel in 868 MHz band to provide a transmission speed up to 20 Kbps. Also, it uses a Direct Sequence Spread Spectrum (DSSS) technology in the PHY layer. Thus, through the ZigBee technology, data can be exchanged with 20 to 250 Kbs transmission speeds in several tens of meters distance, and maximum 255 devices can be connected in a single Personal Area Network (PAN), so that a large-sized wireless sensor network can be constructed in an indoor or outdoor environment.

### SUMMARY

Exemplary embodiments have objectives to provide methods, devices, and a system for providing network accessibility between a consolidated authentication center and a smart home appliance in an environment where multiple home area networks exist.

Illustrative, non-limiting embodiments may overcome the above disadvantages and other disadvantages not described above. The inventive concept is not necessarily required to overcome any of the disadvantages described above, and the illustrative, non-limiting embodiments may not overcome any of the problems described above. The appended claims should be consulted to ascertain the true scope of the invention.

In order to resolve the above-described problem, a smart home appliance (HA) may be provided. The smart HA may be configured to comprise a controller controlling operations of the smart HA; and at least one communication module transmitting/receiving data based on control commands of the controller. Also, the controller may transmit an access request message to a consolidated authentication center, receive an access response message corresponding to the access request message, transmit a pairing request message including device information of the smart HA to the consolidated authentication center, and receive a paring response message corresponding to the paring request message.

Also, in order to resolve the above-described problem, a network management system in which a consolidated authentication center makes a smart home appliance access to a network in an environment where multiple home area networks exist may be provided. In the network management system, the smart HA may transmit an access request message to the consolidated authentication center, the consolidated authentication center may transmit an access response message corresponding to the access request message to the smart HA, the smart HA may transmit a pairing request message including device information of the smart HA to the consolidated authentication center, the consolidated authentication center may allocate a virtual home area network to which the smart HA belongs based on the pairing request message, and the consolidated authentication center may transmit a paring response message corresponding to the pairing request message to the smart HA.

According to exemplary embodiments, a network access between a consolidated authentication center and a smart home appliance becomes possible in an environment where multiple home area networks exist. Especially, in the environment where multiple home area networks exist adjacently, the smart appliances belonging to respective home area networks can access to respective home are networks by utilizing a single consolidated authentication center.

### BRIEF DESCRIPTION OF DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 illustrates respective layers to which ZigBee and IEEE 802.15.4 standard are applied;

FIG. 2 illustrates a configuration of a home area network system of a smart grid related to an exemplary embodiment;

FIG. 3 is a conceptual block diagram illustrating a home area network device according to an exemplary embodiment;

FIG. 4 illustrates a communication frame structure defined in a ZigBee standard and IEEE 802.15.4 standard which are related to an exemplary embodiment;

FIG. 5 illustrates a topology of a ZigBee wireless related to an exemplary embodiment;

FIG. 6 illustrates a relation between a consolidated authentication center and a home area network device in a pairing cluster according to an exemplary embodiment;

FIG. 7 illustrates multiple home area networks related to an exemplary embodiment;

FIG. 8 illustrates a communication step between a consolidated authentication center and a home area network device (e.g. smart HA) according to an exemplary embodiment; and

FIG. 9 illustrates a data section of a pairing response message according to an exemplary embodiment.

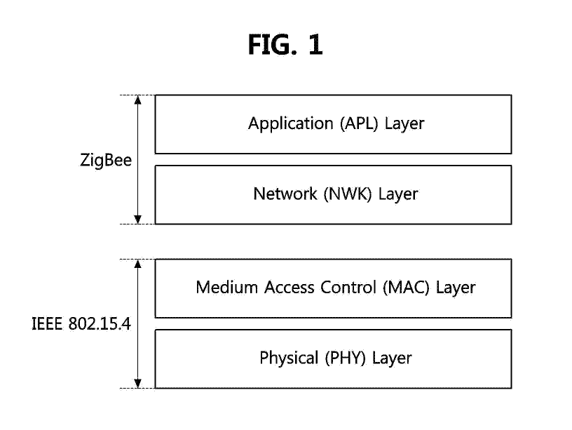

### DETAILED DESCRIPTION OF EXEMPLARY EMBODIMENTS

Since embodiments described in the present specification are intended to clearly describe the spirit of the present invention to those skilled in the art to which the present invention pertains, the present invention is not limited to those embodiments described in the present specification, and it should be understood that the scope of the present invention includes changes or modifications without departing from the spirit of the invention.

The terms and attached drawings used in the present specification are intended to easily describe the present invention and shapes shown in the drawings are exaggerated to help the understanding of the present invention if necessary, and thus the present invention is not limited by the terms used in the present specification and the attached drawings.

In the present specification, detailed descriptions of known configurations or functions related to the present invention which have been deemed to make the gist of the present invention unnecessarily obscure will be omitted below.

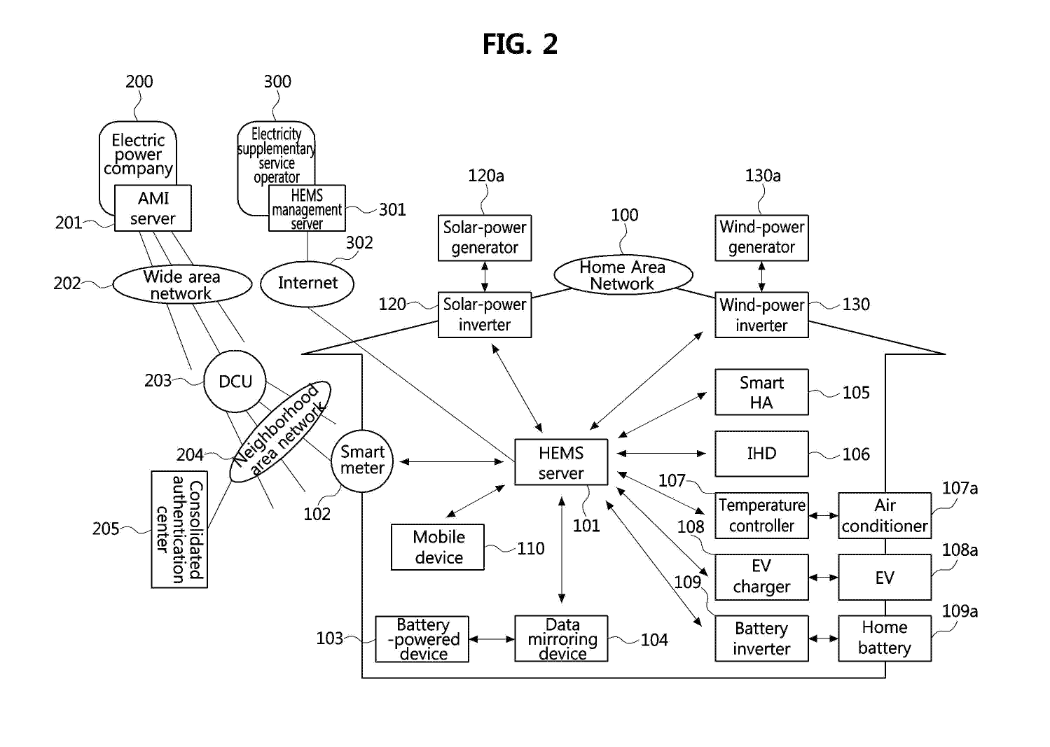

FIG. 2 illustrates a configuration of a home area network system of a smart grid related to an exemplary embodiment.

Referring to FIG. 2, devices in the home area network can include communication modules such as ZigBee, Wi-Fi, Bluetooth, power line communication (PLC), and Ethernet, and perform data communications with each other. The communications inside the home can be performed through the above wired/wireless communications. Also, it is preferable that the respective home area network devices are able to communicate with a HEMS server 101. Also, it is preferable that the respective home area network devices are deployed to be communicable with other home area network devices.

The home area network device may be referred to various devices which need energy control such as a smart home appliance 105, an in-home display 106, a temperature controller 107 connected to and controlling an air conditioner 107a, an electric vehicle (EV) charger 108 configured to charge an EV 108a, a battery inverter 109 controlling charging/discharging of a home battery 109a, a battery-powered device 103 which operates based on a battery, a data minoring device 104 which performs data minoring for the battery-powered device 103, a mobile device 110 of a user, a solar-power inverter 120 converting a direct current generated by a solar-power generator 120a into an alternating current, a wind-power inverted 130 converting a direct current generated by a wind-power generator 130a into an alternating current, etc.

A home energy management system (HEMS) server 101 which is responsible for real-time power management and estimation of demanded power, and a smart meter 102 which meters the amount of power consumption in real time take main roles of the home smart grid.

The HEMS server 101 is a core device of the home energy management system, and performs load controls and energy consumption controls of the home area network devices according to energy-related information received from a HEMS management server 301 administrated by an electric power supplementary service operator 300. The HEMS server 101 may independently exist as a separate physical entity, be embedded in the smart meter 102, or be embedded in the smart appliance 105 such as TV, etc. The HEMS management server 105 may manage the HEMS server 101 of a consumer in a remote site, and configure it.

The smart meter 102 is an electronic metering device having a function of measuring total amount of power consumption of home for respective time bands, and a communication function of transmitting the measured value to an AMI server 201 operated by an electric power company (utility) 200. In comparison to the traditional metering device, the smart meter 102 may have a LCD display, measure power consumption amount in real time, and transmit bi-directionally the measurement result to the electric power company and the consumer via a neighbor area network 204 or a home area network 100. Thus, through the smart meter 102, the electric power company 200 and the consumer respectively may obtain an effect of reducing the costs of manual metering and an effect of reducing consumed energy.

The smart meter installed in office or home may measure the amount of electric power used in the office or home and transmits the measured amount to the AMI server 201. Also, the smart meter may receive a real-time electric charge, a load control message, a notification message, etc. and share the received information with the user or home area network devices. Through this, the user may recognize the currently-used electric power amount or electric charge, and seek for a method for reducing the amount of power consumption or the electric charge.

The Advanced Metering Infrastructure (AMI) system which monitors power consumption rates of respective consumers may be a core infrastructure for the smart grid. The AMI, a system which can collect energy consumption rates in real time, may comprise the smart meter 102 installed in the respective homes and measuring the amount of electric powers used by the respective homes, a data collection unit (DCU) which is a data collecting device collecting data from a plurality of smart meters in the middle, and the AMI server 201 which finally collects the data from a plurality of DUCs 203 through a wide area network 202. Here, the DCU 203 may communicate with nearby smart meters 102 through a neighborhood area network (NAN), and communication with the AMI server 50 through the wide area network (WAN). Also, the smart meters may communicate with home appliances in home through a home area network (HAN) 100. The AMI server 201 is a server located in a network of the electric power company 200, which manages the smart meters 102, transmits information real time energy costs to the smart meters 102, and receives information on real time energy consumption rates of consumers from the smart meters 102.

In the home area grid, electricity can be generated by using the solar-power generator 120a or the wind-power generator 103a and supplied to home itself through the solar-power inverter 120 or the wind-power inverter 130. Alternatively, the electricity generated by them may be resold to an external entity (e.g. electric power company).

The in-home display (IHD) 106, as a device displaying a real time energy consumption rate of the home, may display the amount of electric power used, the amount of water used, the amount of gas used, the amount of electric used for respective home appliances, a real-time energy charge, a real-time quantity of generation, a load control message, a notification message from an electric power company, and various other information.

The mobile device 110 is a portable device which can perform wireless communications with other home area network devices, for example, a smart phone or a portable computer.

In a consumer home, the HEMS server 101, the smart meter 102, and home area network devices exchange messages for demand-response (DR) via an application standard protocol referred to as an energy profile. As an example of the energy profile, there is a ZigBee smart energy profile (SEP). The SEP standard is classified into a SEP 1.x version which operates only in the ZigBee communication technology and a SEP 2.x standard which operates in any communication technologies supporting internet protocol (IP). The SEP is standardized by a ZigBee alliance, and can be equipped in respective devices including the smart meter 102 in the home area network. However, since there are variations for respective functions and nations, there may be devices supporting such the variations (i.e. variations of the SEP).

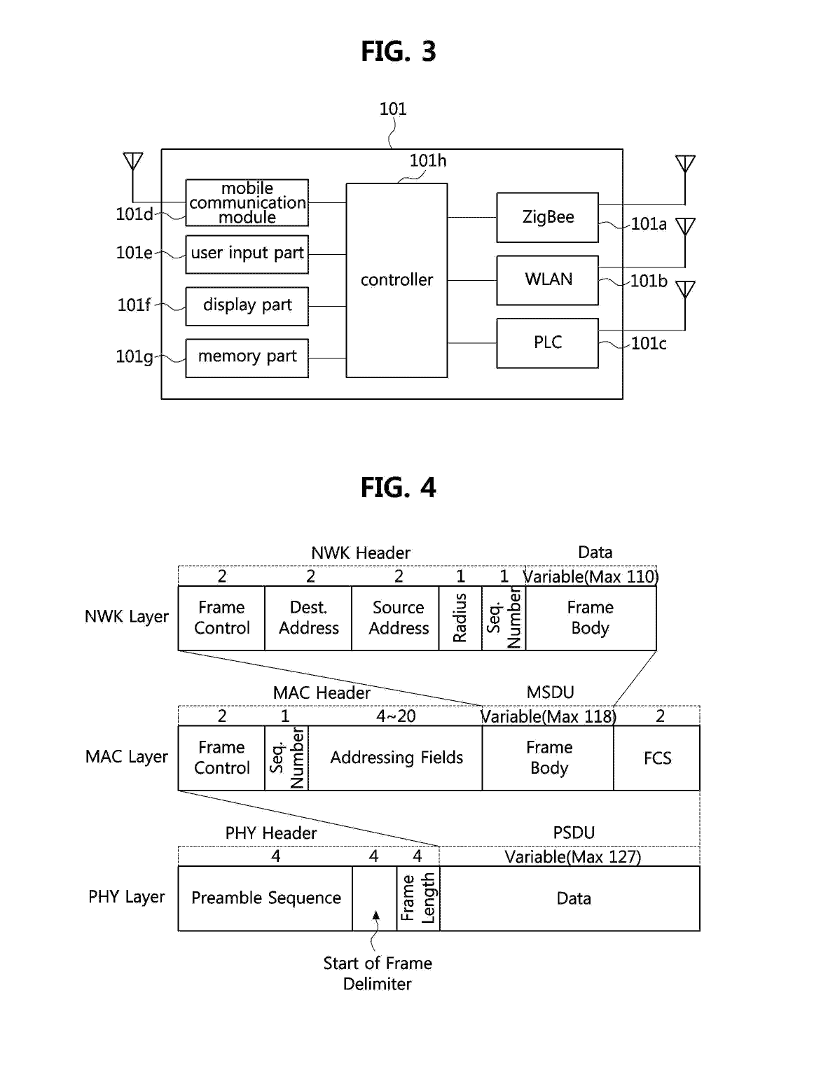

FIG. 3 is a conceptual block diagram illustrating a home area network device according to an exemplary embodiment.

The above device may be one of devices in the home area network 100 illustrated in FIG. 2.

Referring to FIG. 3, the device according to an exemplary embodiment may comprise a communication module for bi-directional communications with other home area network devices, such as a ZigBee 101a, a WLAN 101b, a PLC 101c, or a mobile communication module, a user input part 101e which receives a user input signal, a display part 101f displaying electric power information received from the communication module 101a, 101b, 101c, or 101d or information on the home area network devices, and a controller 101h configured to receive configuration information, the electric power information, or the information on the home area network device through the communication module 101a, 101b, 101c, or 101d, and to control operations of the device including the display part 101f.

The device may comprise a memory part 101g in which control commands or a program code for the device is stored.

Preferably, the controller 101h of the device may control the display part 101f to display the configuration information, the electric power information, or the information on the device in a graphical manner to the user.

The mobile communication module 101d may enable the device to perform data transmission/reception with an external device in a mobile communication network.

The user input part 101e may enable the user to input a command for controlling the device.

The display part 101f may display results of operations of the device and status of the device. Also, the display part 101f may display information provided from an external device.

FIG. 4 illustrates a communication frame structure defined in a ZigBee standard and IEEE 802.15.4 standard which are related to an exemplary embodiment.

The ZigBee supports both of a slotted-mode and a non-slotted-mode. In the slotted-mode, all devices in a PAN perform synchronization by using a beacon message of a PAN coordinator. In the non-slotted mode, a start of a frame is identified by using a preamble signal. Since synchronization signal is shared in the slotted mode, the slotted-mode has an advantage of high network efficiency. However, due to overhead of the synchronization signal, the slotted-mode is not widely used. The above frame structure is defined commonly for the slotted mode-and the non-slotted-mode.

The IEEE 802.15.4 standard defines a PHY layer and a MAC layer, and the ZigBee alliance defines a Network (NWK) layer. In a PHY layer frame, a preamble sequence corresponding to the first four bytes and a start of frame delimiter (SFD) corresponding to one byte subsequent to the preamble sequence indicates a start of the PHY layer frame. The above-described 5 bytes are referred to a synchronization header (SHR). A frame length filed having a length of 1 byte is subsequent to the SHR, and indicates the length of a PHY layer Service Data Unit (PSDU) following the frame length field. The PSDU is a data set including signals of the MAC layer, and the maximum length of the PSDU is 127 bytes.

A MAC layer frame starts with a frame control filed having a length of 2 bytes. Also, a sequence number field having a length of 1 byte and addressing fields having a length of 4 bytes to 20 bytes are subsequent to the frame control field. It depends on the length of the addressing fields whether to use a short address or an IEEE address longer than the short address in a PAN. After then, a frame body comprising data of a NWK layer follows. At the last of the MAC layer frame, there is a frame check sequence (FCS) field for detection of an error in the frame. A data payload is also referred to as a MAC layer Service Data Unit (MSDU). If the length of the PSDU of the PHY layer is 127 bytes at its maximum, the maximum length of the MSDU may be 118 bytes, excluding the MAC header of 7 bytes and the FCS field of 2 bytes.

The essential fields in a NWK header are a frame control filed of 2 bytes, a recipient address filed of 2 bytes, a source address field of 2 bytes, a radius field of 1 byte, and a sequence number field of 1 byte. That is, the essential fields have a length of 8 bytes totally. If the length of the MSDU is 118 bytes at its maximum, the maximum payload which can be used in the NWK layer may be 110 bytes, excluding the NWK header of 8 bytes.

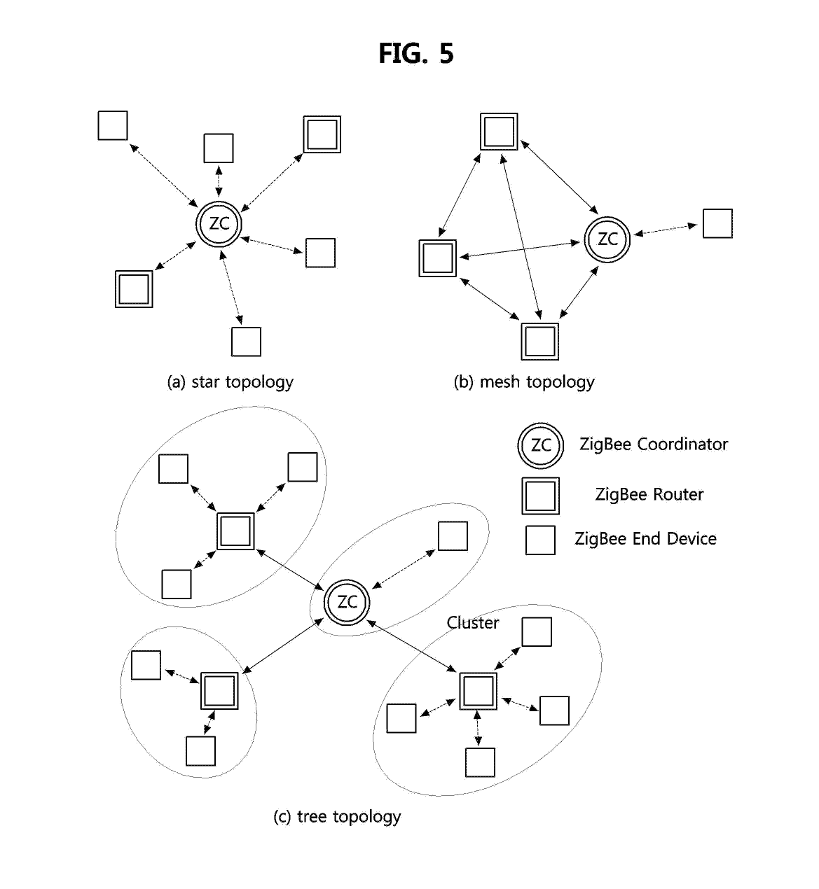

FIG. 5 illustrates a topology of a ZigBee wireless related to an exemplary embodiment.

The ZigBee standard defines three types of network topologies—star, tree, and mesh. Also, the ZigBee standard defines three types of network nodes.

A ‘coordinator’ performs a core role of a network, manages information on all devices connected to a network. Only a Full Function Device (FFD) defined in IEEE 802.15.4 can act as a coordinator.

A ‘router’ does not exist in the star topology. Thus, the router can be applied to only the star topology and the mesh topology. The router performs a role of connecting the coordinator to an end device. Only a FFD device can act as a router. The router can perform a role of an end device at the same time. In this case, the router may be treated as an end device.

An ‘end’ device is an end node of the network which collects sensor data, transmits them, or performs control operations under commands of the coordinator. Usually, an end device may be a Reduce Function Device (RFD) defined in IEEE 802.15.4 which has smaller memory, lower power consumption, and cheaper price as compared to the FFD device.

In the star topology whose implementation is the simplest, the ZigBee coordinator is located in the center of the network, and end devices directly connected to the coordination. In order for an end device to transmit to another end device, the coordinator should relay the data, and thus two links (hops) in which the coordinator participates become necessary. Thus, in a case that adjacent two end devices communicate with each other, inefficiency arises.

In the mesh topology, the coordinator is located in the center of the network, and end devices or routers are connected to the coordinator. Also, a router may be connected to other routers or directly to an end device, and thus the network can grow in size. The difference between the tree topology and the mesh topology is that respective nodes can have multiple parent nodes not a single parent node. Since the mesh topology has a complicated network configuration and each router should have information on all nodes, it has a disadvantage of demanding a large memory. However, even when a single node is lost, a bypass path (i.e. failover path) can be immediately obtained so that higher network reliability can be expected. Also, since it is possible to transmit data through a shortest path without passing the coordinator, overall traffic can be reduced.

In the tree topology, the coordinator is located in the center of the network, and end devices or routers are connected to the coordinator. Also, a router may be connected to other routers or directly to an end device, and thus the network can grow in size. (It is similar to the mesh topology, and the difference between the mesh topology and the tree topology has been already explained above.) Since all data are concentrated on the coordinator in the tree topology, there is a disadvantage that overall traffic increases.

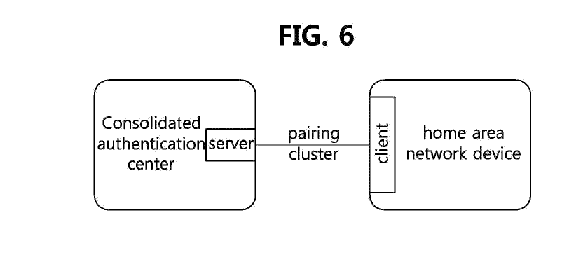

FIG. 6 illustrates a relation between a consolidated authentication center and a home area network device in a pairing cluster according to an exemplary embodiment.

The consolidated authentication center may perform a role of a server of a pairing cluster, and home area network devices may perform roles of clients.

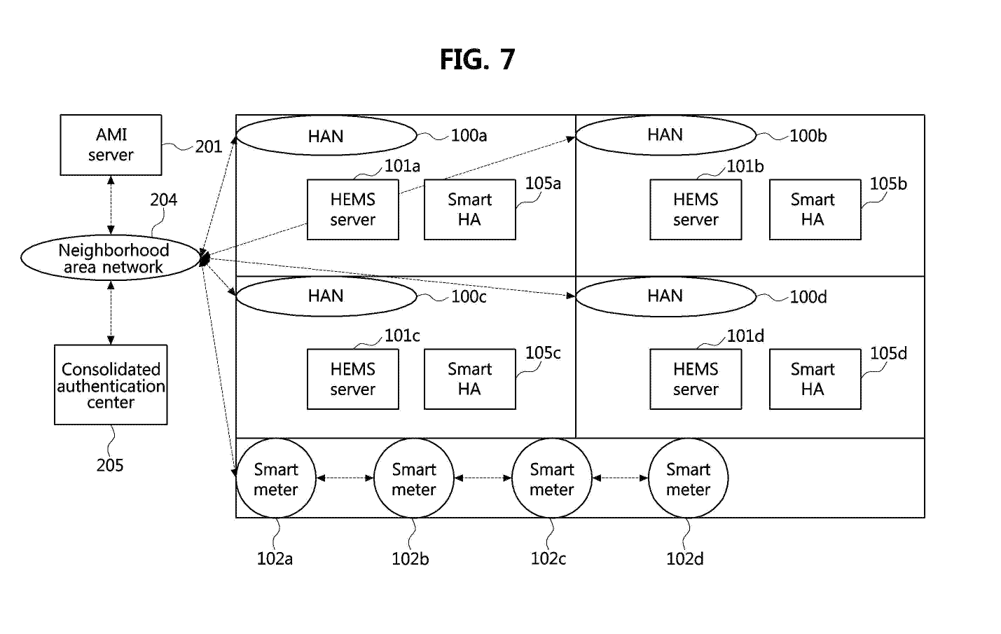

FIG. 7 illustrates multiple home area networks related to an exemplary embodiment.

The cases in which multiple home area networks exist adjacently may occur according to the following reasons. The first case is that a HEMS server of an electric power company and a HEMS server of an electric power supplementary service operator are different for the same consumer. The second case is that one or more HEMS servers can be maintained separately for different commodities such as electric power, gas, water, etc. The third case is that multiple home area networks and smart meters belonging to them exist as overlapped in a same space, for example, a dense apartment environment. In this case, respective home area networks 100 can communicate with each other through neighborhood area network. In the third case, it is preferred that multiple home area networks are managed by a single consolidated authentication center.

In this case, it is better to maintain a single consolidated authentication center for multiple home area networks as compared to a configuration that individual authentication centers 102 exist for respective home area networks 100. Through the use of the single consolidated authentication center, unnecessary user involvement for respective home area networks can be minimized The single consolidated authentication center may also referred to as a ‘Federated Trust Center (FTC)’, and it may control overall networks (MDU networks).

Referring to FIG. 7, a case in which multiple households reside in a single building (e.g. 4 families in FIG. 7) is illustrated. Each household may have a HEMS server 101 and home area network devices 100 such as a smart home appliance 105.

However, in the above situation, smart meters 102 for measuring power consumption of respective households may together be installed in a basement or a ground floor for convenience of management. In this case, a home area network can be configured into a virtual home area network by combining the HEM server 101, the smart HA 105, and smart meters 102 located remotely. Preferably, for connections among the remote devices, a communication range extender (e.g. repeater or relay) for maintaining the connections may be deployed in each floor.

In the case that multiple home area networks are configured in the above manner, there may be a consolidated authentication center (FTC) 205 which manages accesses and pairing of all devices, the smart meters 102 belonging to respective virtual home area networks, the HEMS server 101 managing respective home area networks, the smart HAs 105 belonging to respective home area networks, and neighborhood area networks 204 connecting them through communications.

The HEMS server may exist as a physically separated apparatus. Alternatively, it may exist as combined into the smart meter 102.

The following technologies may be inherent in the multiple home area networks.

It may be preferable that a single ZigBee network through which all devices of the multiple home area networks can communicate is configured to cover all regions. For this, devices excluding end devices among ZigBee devices may preferably activate their routing functions so that all devices can be connected as a mesh network.

Also, for security, it may be preferable that all devices of the multiple home area networks use a same network security key and the single consolidated authentication center 205 manages their network accesses. Thus, devices belonging to the same home area network 100 may perform binding procedures through the consolidated authentication center 205, and use allocated application layer link key so that other devices existing in nearby home area network 205 cannot identify content of exchanged message. Although devices belonging to different home area networks can perform routing on messages from devices in other home area network, they do not have a security key for actually decrypting the messages.

Through such the logical separation of networks using the security key, a plurality of virtual home area networks may be configured among the multiple home area networks. Each virtual home area network may comprise a HEMS server 101, home area network devices 100 such as smart HAs, and remote smart meters 102. In the environment where multiple home area networks exist, the virtual home area network may be formed between devices existing in respective home area networks. Here, entities constituting the single virtual home area network may be smart meters 102 of the corresponding household, the HEMS server 101, and the smart HAs 105.

It may be preferable that a home area network device which newly accesses a home area network 100 does not use a service discovery technique for a conventional single network. If the conventional service discovery technique is used, a corresponding message may be delivered to nearby home area networks. In order to prevent the above situation, it may be preferable that the consolidated authentication center 205 transmits a list of communicable devices to the newly-accessed device.

The consolidated authentication center 205 may acquire list information of devices to constitute a virtual home area network for each household. The information may be received from an AMI server 201 managed by the electric power company. It may be preferable that a device which newly joins multiple home area networks receives information on which virtual home area network is allocated to it. Through this, the service discovery in the new network may be performed efficiently. That is, a service discovery of a new device may be restricted to a virtual home area network to which the new device will belong.

When a new device enters into a neighborhood area network managed by the consolidated authentication center 205, it should successfully perform a security key exchange with the consolidated authentication center.

Then, the new device may request pairing information to the consolidated authentication center 205. Upon receiving the pairing information from the consolidated authentication center 205, the new device may restrict its service discovery to devices listed in the pairing information. That is, the pairing response message received from the consolidated authentication center may include a list of devices of a virtual home area network to which the new device belongs. Therefore, it is preferable that the service discovery message is transmitted in unicast or multicast manner not broadcast manner

The devices may withdraw from the virtual home area network or move to a nearby virtual home area network. For this, devices belonging to the neighborhood area network 204 may query the consolidated authentication center 205 about whether new pairing information exists or not. According to pairing version information included in the message, novelty of the received pairing information may be determined.

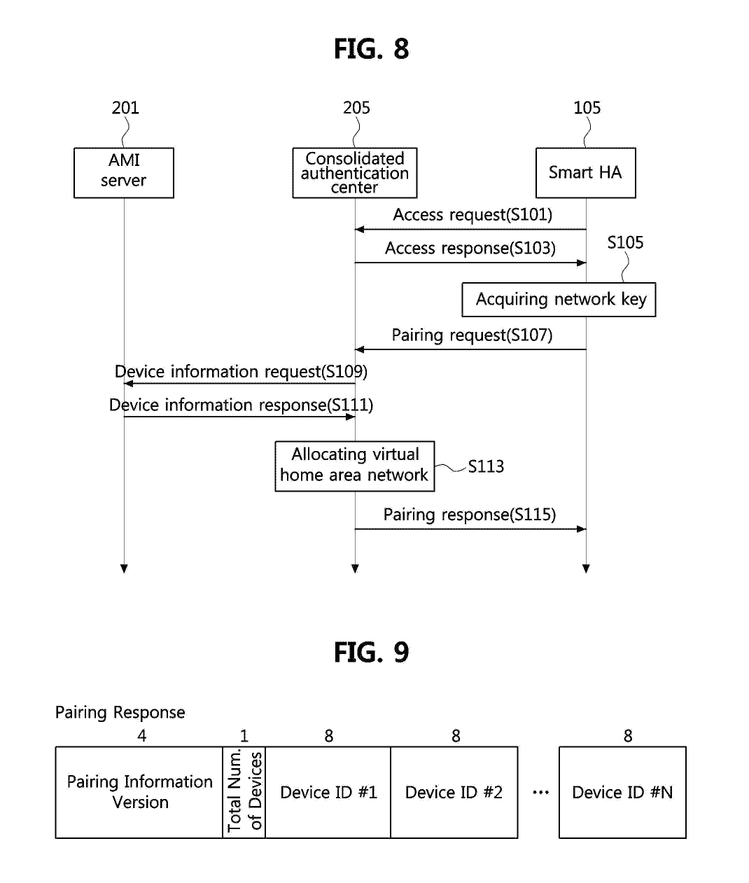

FIG. 8 illustrates a communication step between a consolidated authentication center and a home area network device (e.g. smart HA) according to an exemplary embodiment.

In an exemplary embodiment, a smart HA 105 may be utilized as an example of a home area network device. In addition to the smart HA, other home area network devices such as a HEMS server, an IHD, or a temperature controller may perform a step similar to the communication step.

The smart HA 105 may transmit an access request message to the consolidated authentication center 205 (S101). In the step S101, the smart HA 105 and the consolidated authentication center 205 may perform authentication and key exchange Through this, the smart HA 105 may obtain a network key (S105).

The smart HA 105 may transmit a pairing request message to the consolidated authentication center 205 to communicate with other devices of the virtual home area network to which it belongs (S107).

The consolidated authentication center 205 may transmit a device information request to the AMI server to obtain information of the virtual home area network to which the smart HA 105 belongs (S109). The device information request may include a MAC address of the smart HA. The AMI server 201 may transmit a device information response message corresponding to the device information request to the consolidated authentication center 205. The device information response message may include information on the virtual home area network to which the smart HA 105 belongs.

According to another exemplary embodiment, in the above step, the consolidated authentication center 205 may use information on the virtual home area network to which the smart HA 105 belongs which is already stored in a database of the consolidated authentication center 205.

According to yet another exemplary embodiment, the smart HA 105 may include the information on the virtual home area network of the smart HA 105 in the pairing request message.

The consolidated authentication center 205 may allocate the virtual home area network to which the smart HA 105 belongs (S113), and transmit the corresponding information as included in a pairing response message (S115).

It is preferable that the pairing response message includes a list of other devices existing in the virtual home area network to which the smart HA 105 belongs.

The smart HA 105 may transmit a service discovery message to the devices in the list in unicast manner or multicast manner. Each of the devices receiving the service discovery message may transmit a service response message in response to the service discovery message. The smart HA 105 may perform binding with services of the devices based on the service response messages transmitted from the devices.

In a case that the device wants to change a virtual home area network to which it belongs, the following steps may be performed—a step in which the device transmits a pairing request message to the consolidated authentication center; a step in which the consolidated authentication center analyzes whether the virtual home area network of the device can be changed; a step in which the consolidated authentication center transmits a pairing response message include a list of devices which can be accessed to the device based on a result of the analysis; a step in which the device does not perform a binding request when the list is identical to the previous one; and a step in which the device performs a new binding request when the list is different from the previous one.

FIG. 9 illustrates a data section of a pairing response message according to an exemplary embodiment.

Referring to FIG. 9, the ‘pairing information version’ field may indicate a sequence number of pairing information included in a current message. When multiple pairing response messages are transmitted for a single pairing request, it may be preferable that the above fields of them are configured to have the same value. Also, it may be preferable that the pairing response message including the same version information is transmitted to all devices existing in the same virtual home area network at an arbitrary time. If a new device successfully joins the corresponding virtual home area network, the value of the version field can be updated to a higher value.

Also, the ‘total number of devices’ field may indicate the number of all devices existing in the virtual home area network which the device requests to join. It may be preferable that the number of all devices is counted by including the device which transmitted the pairing request message. The value of this field may increase or decrease according to change of the number of devices in the virtual home area network.

Also, the ‘device ID’ field may indicate MAC addresses of the devices belonging to the virtual home area network. Similarly to the ‘total number of devices’ field, it may be preferable that the ‘device ID’ field is configured by including a MAC address of the device which transmitted the pairing request message.

Upon receiving the pairing response message comprising the above fields, the smart HA 105 may perform a service discovery procedure for devices having addresses included in the device ID field of the received pairing response message.

While exemplary embodiments have been described above in detail, it should be understood that various modification and changes may be made without departing from the spirit and scope of the inventive concept as defined in the appended claims and their equivalents.

1. A smart home appliance (HA) comprising:
a controller controlling operations of the smart HA; and
at least one communication module transmitting/receiving data based on control commands of the controller,
wherein the controller transmits an access request message to a consolidated authentication center, receives an access response message corresponding to the access request message, transmits a pairing request message including device information of the smart HA to the consolidated authentication center, and receives a paring response message corresponding to the paring request message.

2. The smart HA according to claim 1, wherein the access response message includes a network key of multiple home area networks.

3. The smart HA according to claim 1, wherein the pairing request message includes information on a virtual home area network to which the smart HA belongs.

4. The smart HA according to claim 1, wherein the information on the virtual home area network to which the smart HA belongs is obtained from an advanced metering infrastructure (AMI) server by using the device information of the smart HA obtained from the paring request message.

5. The smart HA according to claim 1, wherein the pairing response message includes list information of devices belonging to the virtual home area network to which the smart HA belongs.

6. A network management system in which a consolidated authentication center makes a smart home appliance (HA) access to a network in an environment where multiple home area networks exist, wherein:
the smart HA transmits an access request message to the consolidated authentication center;
the consolidated authentication center transmits an access response message corresponding to the access request message to the smart HA;
the smart HA transmits a pairing request message including device information of the smart HA to the consolidated authentication center;
the consolidated authentication center allocates a virtual home area network to which the smart HA belongs based on the pairing request message; and
the consolidated authentication center transmits a paring response message corresponding to the pairing request message to the smart HA.

7. The network management system according to 6, wherein the access response message includes a network key of multiple home area networks.

8. The network management system according to 6, wherein the pairing request message includes information on a virtual home area network to which the smart HA belongs.

9. The network management system according to 6, wherein the information on the virtual home area network to which the smart HA belongs is obtained from an advanced metering infrastructure (AMI) server by using the device information of the smart HA obtained from the paring request message.

10. The network management system according to 6, wherein the pairing response message includes list information of devices belonging to the virtual home area network to which the smart HA belongs.

11. A network access method between a consolidated authentication center and a smart home appliance (HA) in an environment where multiple home area networks exist, performed in the consolidated authentication center, the method comprising:
receiving an access request message from the smart HA;
transmitting an access response message corresponding to the access request message;
receiving a pairing request message including device information of the smart HA from the smart HA;
allocating a virtual home area network to which the smart HA belongs based on the paring request message; and
transmitting, to the smart HA, a pairing response message corresponding to the pairing request message.

12. The network access method according to 11, wherein the access response message includes a network key of multiple home area networks.

13. The network access method according to 11, wherein the pairing request message includes information on a virtual home area network to which the smart HA belongs.

14. The network access method according to 11, wherein the information on the virtual home area network to which the smart HA belongs is obtained from an advanced metering infrastructure (AMI) server by using the device information of the smart HA obtained from the paring request message.

15. The network access method according to 11, wherein the pairing response message includes list information of devices belonging to the virtual home area network to which the smart HA belongs.

16. A consolidated authentication center apparatus comprising:
a controller controlling operations of the consolidated authentication center; and
at least one communication module transmitting/receiving data based on control commands of the controller,
wherein the controller receives an access request message from the smart HA, transmits an access response message corresponding to the access request message, receives a pairing request message including device information of the smart HA from the smart HA, allocates a virtual home area network to which the smart HA belongs based on the paring request message, and transmits a pairing response message corresponding to the pairing request message to the smart HA.

17. The consolidated authentication center according to 16, wherein the access response message includes a network key of multiple home area networks.

18. The consolidated authentication center according to 16, wherein the pairing request message includes information on a virtual home area network to which the smart HA belongs.

19. The consolidated authentication center according to 16, wherein the information on the virtual home area network to which the smart HA belongs is obtained from an advanced metering infrastructure (AMI) server by using the device information of the smart HA obtained from the paring request message.

20. The consolidated authentication center according to 16, wherein the pairing response message includes list information of devices belonging to the virtual home area network to which the smart HA belongs.
